(19) United States
(12) Patent Application Publication
(10) Pub. No.: US 2006/0200944 A1
(43) Pub. Date: Sep. 14, 2006

(54) Hinge

(76) Inventor: Luciano Salice, Carimate (IT)

Correspondence Address: DILWORTH & BARRESE, LLP, 333 EARLE OVINGTON BLVD., UNIONDALE, NY, 11553, US

(21) Appl. No.: 11/080,003

(22) Filed: Mar. 14, 2005

(51) Int. Cl. E05F 1/08

(52) U.S. Cl. 16/286

(57) ABSTRACT

The invention relates to a hinge, preferably a furniture hinge, consisting of a hinge arm which is pivotably supported on an articulated axle held immovably in a cup-shaped hinge part and which is provided with a tongue projecting beyond the articulated axle or with a cam eccentric to the articulated axle or with a control edge which slide on a leaf spring held at an end region on the pivotable hinge part and generating a closing torque in the closing region. In accordance with the invention, the leaf spring has at least two sections of different width, with the at least one narrower section of the leaf spring having an elongatedly formed rib up to the transition region of the at least one wider section of the leaf spring.

The invention relates to a hinge, preferably a furniture hinge, consisting of a hinge arm which is pivotably supported on an articulated axle held immovably in a cup-shaped hinge part and which is provided with a tongue projecting beyond the articulated axle or with a cam eccentric to the articulated axle or with a control edge which slide on a leaf spring held at an end region on the pivotable hinge part and generating a closing torque in the closing region.

A hinge known from DE 36 01 682 A1 of the previously recited kind has a leaf spring whose bent end is held in a slot of the base of the cup-shaped hinge part and whose middle part is supported against a spigot projecting laterally into the hinge cup such that the resilient end of the leaf spring acts on a control edge of the hinge arm. The lateral arrangement of the leaf spring reduces the width of the hinge arm and therefore also the strength of the total hinge. The lateral arrangement of the leaf spring also has the effect that it can only be made in narrow form. It follows from this that no large closing torque can be generated.

An embodiment of the hinge initially explained is known from U.S. Pat. No. 5,546,956 A in which the leaf springs have two-sided tongues which are likewise made in narrow form and in which the leaf spring itself is only held at the base hinge cup by a rivet. This likewise has the effect that the leaf spring disclosed there cannot exert any large closing torque. The leaf spring generating the closing torque moreover requires a lot of space in the hinge cup so that such a hinge cannot be considered for compact embodiments which are, for example, desired in thin doors.

A wire spring is known from U.S. Pat. No. 5,604,956 A as the spring element generating the closing torque which is secured beneath the base hinge cup in a complex manner. The free ends of the wire spring project from lateral cut-outs into the interior space of the hinge cup and are supported at lateral cams of the hinge arm. This embodiment is very complex and expensive and corresponds in its effect to a hinge in accordance with European patent EP 0.987 394 B1 which goes back to the same applicant as the present invention.

It is the object of the present invention to further develop a generic hinge comprising components which are simple to manufacture, such as a hinge arm and a hinge cup, such that a leaf spring generating the closing torque can be secured in a space-saving manner in the cup-shaped hinge part in a simple and thus economic manner, with the spring properties of the leaf spring simultaneously being utilized in the best possible manner to achieve a better function of the hinge.

This object is solved by the features of claim 1. Accordingly, a hinge consists of a hinge arm which is pivotably supported on an articulated axle held immovably in a cup-shaped hinge part. Is provided with a tongue projecting beyond the articulated axle or with a cam eccentric to the articulated axle or with a control edge which slide on a leaf spring held at an end region on the pivotable hinge part and generating a closing torque in the closing region. In accordance with the invention, the leaf spring has at least two sections of different width, with the at. least one narrower section of the leaf spring having an elongatedly made rib up to the transition region up to the at least one wider section of the leaf spring. This means that the rib extends along the leaf spring. Due to this longitudinally extending rib, the bending of the leaf spring does not take place in its narrower section, but in the wider section which is held on the base of the hinge cup. In this wider section and in the transition region leading to it, the leaf spring exerts a larger force with a lower bend and its service life is not influenced in any way by possible micro-breaks originating from the production process. Notches or cut-outs are furthermore also present which can likewise reduce the spring force, but whose influence is negated by the rib so that the spring can be given the desired shape.

Preferred aspects of the invention result from the subordinate claims depending on the main claim.

The at least one wide section of the leaf spring can advantageously be pressed against the base of the hinge cup by a transversely extending pin and can thus be held tight.

The base of the hinge cup advantageously has a cut-out in the region in which the at least one wider section of the leaf spring is arranged. The spacing between the transversely extending pin and the base can be dimensioned to be smaller than the thickness of the leaf spring. The leaf spring can have a transversely extending indentation at its region disposed beneath the transversely extending pin, said indentation optionally dipping into the cut-out of the hinge cup and thus holding the leaf spring in its correct and centered position.

The longitudinally extending rib can extend up to three-quarters of the length of the transition region between the two sections of the leaf spring at least present.

In accordance with a further preferred aspect of the invention, the hinge arm can have a cut-out from whose lower edge the tongue is cut out such that the lower edge of the cut-out has two sections next to the cut-out tongue on which the leaf spring can be supported in the completely open position of the hinge. The spacing of the two sections from the articulated axle can be the same or only slightly larger than the spacing of the outer edge of the tongue from the articulated axle. While the leaf spring is therefore supported on the tongue during the opening or closing of the hinge, it is supported on the additional two sections in the fully open position of the hinge.

Further features, details and advantages of the invention are shown with reference to an embodiment explained in more detail in the drawing. There are shown:

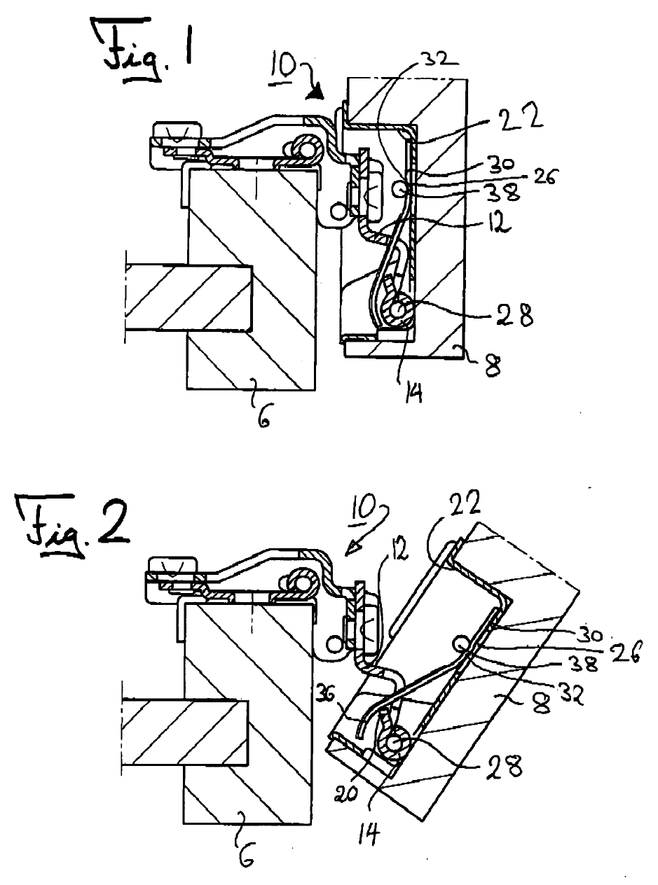

FIG. 1: a longitudinal section through a hinge in accordance with the invention in the closed state;

FIG. 2: the hinge in accordance with FIG. 1 in a state open by approximately 30°;

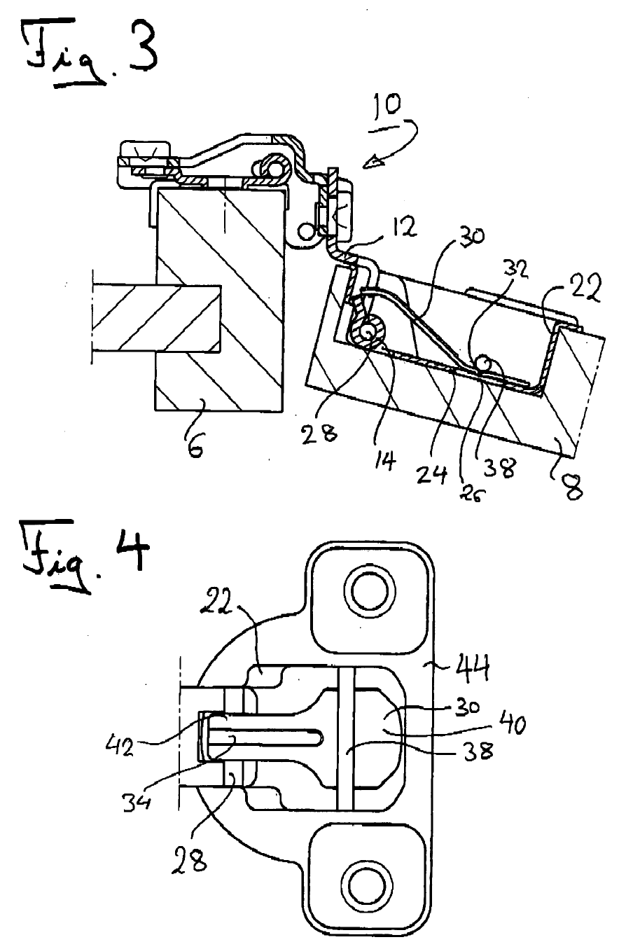

FIG. 3: the hinge in accordance with FIG. 1 in the completely open state;

FIG. 4: a plan view of the cup-shaped hinge part;

FIG. 5: a plan view of the leaf spring of the hinge;

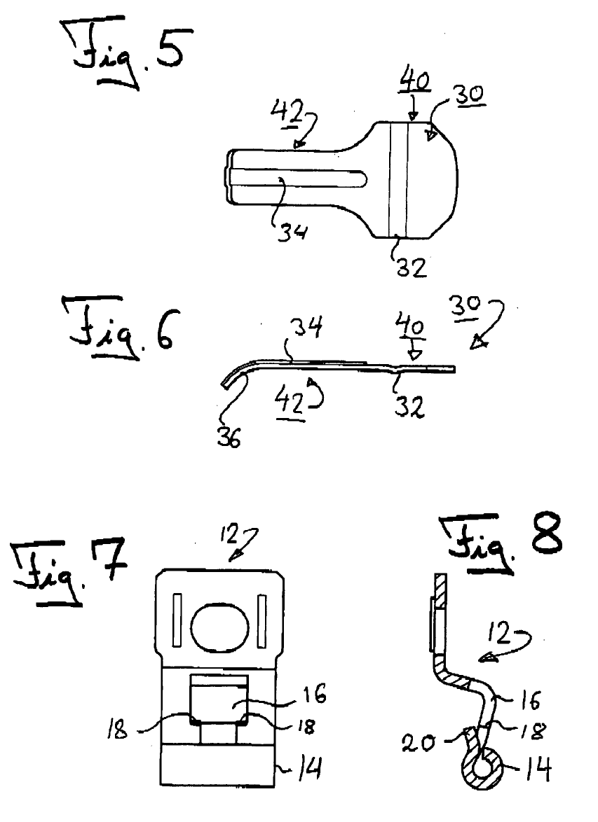

FIG. 6: a side view of the leaf spring in accordance with FIG. 5;

FIG. 7: a plan view of the hinge arm; and

FIG. 8: a sectional view of the hinge arm in accordance with FIG. 7.

The hinge visible from FIGS. 1 to 3 substantially consists of a hinge arm 12 which is provided with an angled bend and whose lower, rolled-in end 14 encompasses an articulated axle 28. The articulated axle 28 is held immovably in the usual manner in the side walls of the hinge cup 22. This hinge cup 22 is inserted in the usual manner into a flat blind-hole bore, for example of a door 8, which is pivotably connected via the hinge 10 to a carcass 6 of a piece of furniture and which is connected to the latter via a flange 44 which is part of -the hinge cup 22 (cf. FIG. 4).

The hinge arm 12 bent at an angle is shown in individual representation in FIGS. 7 and 8. This hinge arm 12 has, as already stated above, a middle cut-out 16, out of whose lower edge a tongue 20 is cut out, .at its lower rolled-in end 14 which encompasses the articulated axle 28 in the installed state. The width of the tongue 20 is lower than the total width of the cut-out 16 so that short sections 18 are formed in the lower edge region of the cut-out 16 at both sides of the cut-out and bent back tongue 20.

As can in particular be seen from FIG. 8, the tongue 20 is offset from the rolled-in edge 14 of the hinge arm so that its manufacture is substantially simplified.

As can be seen from the FIGS. 1 to 3, a transverse pin 38 is secured at the end of the hinge cup 22 (in its side walls) disposed opposite the articulated axle 28 and a leaf spring 30 is held between the transverse pin 38 and the base 24 of the hinge cup 22.

In the embodiment shown here, there is a lower spacing between the transverse pin 38 and the base 24 of the hinge cup 22 than that of the width of the leaf spring 30. In this region, the base 24 of the hinge cup 22 has a cut-out 26 whose width corresponds to that of the leaf spring 30. At the part disposed beneath the transverse pin 38, the leaf spring 30 advantageously has a transversely extending indentation or dimple 32 which dips partly into the cut-out 26 of the base 24 of the hinge cup 22 and thus holds the leaf spring in its correct and centered position.

The leaf spring 30 is shown individually in FIGS. 5 and 6. It substantially has two sections 40 and 42. The section 42 is a narrower section which merges, in a transition region, into the wider section 40 of the leaf spring 30. The narrower section 42 has a curved end region 36. A rib 34 extends as a reinforcing rib along the narrow section 42. It extends up to and into approximately three-quarters of the length of the transition region between the sections 42 and 40 of the leaf spring 30.

In FIG. 1, the hinge in accordance with the invention is shown in a closed position, that is a door 8 closes an opening of the carcass 6 of the piece of furniture.

In FIG. 2, the hinge 10 can be seen in its position open by approximately 30°. From this position, the tongue 20 slides in the opening direction along the curved end region 36 of the leaf spring 30 whose radius of curvature corresponds to the spacing of the outer edge of the tongue 20 from the articulated axle 28 so that the spring no longer carries out a bend in this pivot region of the hinge. However, before the tongue 20 reaches this angular position of 30°, it is supported with respect to the leaf spring 30 such that the leaf spring generates a closing torque in this closing region. The rib 34 in the smaller section 42 has the effect that the strength of this region reinforced by the rib is increased so that the leaf spring 30 is only bent in the region of the transverse pin 38. In this region, the leaf spring is made wider so that here a comparatively larger force can be generated with a lower bend.

In FIG. 3, the hinge is shown in its open position. Since the tongue 20 is manufactured by a simple bending out in a simple manner, this cannot ensure any sufficiently large support surface for the leaf spring 20. In the open position of the hinge 10, the leaf spring 30 is therefore supported at the edges 18 of the cut-out 16 of the hinge arm 12 arranged to the side next to the tongue 20. The spacing of these edges from the articulated axle 28 substantially corresponds to the spacing of the outer edge of the tongue 20 from this articulated axle 28. The support of the spring is therefore passed on at the opening pivot movement from the tongue 20 to the short sections 18 in the region of the cut-out 16 of the hinge arm 12 in the maximum open position shown in FIG. 3, with the leaf spring 30 not having any further bending stress applied to it.

1. A hinge, preferably a furniture hinge, having a hinge arm which is pivotably supported on an articulated axle held immovably in a cup-shaped hinge part and provided with a tongue projecting beyond the articulated axle, a cam eccentric to the articulated axle or control edge which slide on a leaf spring held at an end region on the pivotable hinge part and generating a closing torque in the closing region,
wherein
the leaf spring has at least two sections of different width, with an at least one narrower section of the leaf spring having an elongated by formed rib up to a transition region of an at least one wider section of the leaf spring.

2. A hinge in accordance with claim 1, wherein the at least one wider section of the leaf spring is pressed against the base of the hinge cup by a transversely extending pin and is thus held fast.

3. A hinge in accordance with claim 1, wherein the base of the hinge cup has a cut-out in the region in which the at least one wider section of the leaf spring is arranged.

4. A hinge in accordance with claim 2, wherein the spacing between the transverse pin and the base is smaller than the thickness of the leaf spring.

5. A hinge in accordance with claim 2, wherein the leaf spring has a transversely extending indentation at its region disposed beneath the transverse pin, said indentation optionally dipping into the cut-out of the hinge cup.

6. A hinge in accordance with claim 1, wherein the longitudinally extending rib extends up to three-quarters of the length of the transition region between both sections of the leaf spring.

7. A hinge in accordance with claim 1, wherein the hinge arm has a cut-out from whose lower edge the tongue is cut out such that the lower edge of the cut-out has two sections next to the cut-out tongue on which the leaf spring is supported in the completely open position of the hinge.

8. A hinge in accordance with claim 7, wherein the spacing of the two sections from the articulated axle is the same or only slightly larger than the spacing of the outer edge of the tongue from the articulated axle.

9. A hinge in accordance with claim 1 wherein the leaf spring has a curved end region in the region of its narrower section.

10. A hinge in accordance with claim 1, wherein the base of the hinge cup has a cut-out in the region in which the at least one wider section of the leaf spring is arranged.

11. A hinge in accordance with claim 10, wherein the spacing between the transverse pin and the base is smaller than the thickness of the leaf spring.

12. A hinge in accordance with claim 2, wherein the spacing between the transverse pin and the base is smaller than the thickness of the leaf spring.

13. A hinge in accordance with claim 3, wherein the spacing between the transverse pin and the base is smaller than the thickness of the leaf spring.

14. A hinge in accordance with claim 13, wherein the leaf spring has a transversely extending indentation at its region disposed beneath the transverse pin, said indentation optionally dipping into the cut-out of the hinge cup.

15. A hinge in accordance with claim 3, wherein the leaf spring has a transversely extending indentation at its region disposed beneath the transverse pin, said indentation optionally dipping into the cut-out of the hinge cup.

16. A hinge in accordance with claim 4, wherein the leaf spring has a transversely extending indentation at its region disposed beneath the transverse pin, said indentation optionally dipping into the cut-out of the hinge cup.

17. A hinge in accordance with claim 10, wherein the leaf spring has a transversely extending indentation at its region disposed beneath the transverse pin, said indentation optionally dipping into the cut-out of the hinge cup.

18. A hinge in accordance with claim 11, wherein the leaf spring has a transversely extending indentation at its region disposed beneath the transverse pin, said indentation optionally dipping into the cut-out of the hinge cup.

19. A hinge in accordance with claim 12, wherein the leaf spring has a transversely extending indentation at its region disposed beneath the transverse pin, said indentation optionally dipping into the cut-out of the hinge cup.

20. A hinge in accordance with claim 19, wherein the longitudinally extending rib extends up to three-quarters of the length of the transition region between both sections of the leaf spring.
